(19) United States
(12) Patent Application Publication
(10) Pub. No.: US 2013/0163240 A1
(43) Pub. Date: Jun. 27, 2013

(54) LED STREET LAMP

(71) Applicants: Chien-Yuan Chen, New Taipei City (TW); Ying-Te Chuang, New Taipei City (TW)

(72) Inventors: Chien-Yuan Chen, New Taipei City (TW); Ying-Te Chuang, New Taipei City (TW)

(21) Appl. No.: 13/612,836

(22) Filed: Sep. 13, 2012

(30) Foreign Application Priority Data
Dec. 23, 2011 (TW) 100148197

(51) Int. Cl. F21V 29/00; F21V 5/04; F21V 21/00

(52) U.S. Cl. 362/235; 362/249.02

(57) ABSTRACT

An LED street lamp includes a base having an end forming a connection head and an opposite end rotatably coupled to a rotatable LED lamp body. The lamp body includes therein heat pipes to which a flexible circuit board carrying LEDs is mounted. Multiple lamp components are connected in a cascade form to constitute the lamp body, whereby when the LEDs emit light, the heat generated can be dissipated away by the heat pipes. Further, each LED light source is set in a given direction according to a trough defined in the lamp component that receives the LED light source so that uniform and bright lighting can be obtained. The device is connectable to an existing street lamp in order to save the great expense for replacing the whole street lamp.

### TECHNICAL FIELD OF THE INVENTION

The present invention generally relates to an LED (Light-Emitting Diode) street lamp that is in compliancy with the existing street lamp specifications, such as E39/E40 or similar standards.

### DESCRIPTION OF THE PRIOR ART

With the years' use and experience of street lamps, it is found that the best configuration of a street lamp is that shown in FIG. 15 of the attached drawings, in which a curved metal hood 70 forms an upper portion of the lamp and a curved glass cover 71 is attached under the hood 70. A socket 72 is arranged at an end inside the hood 70 and the cover 71 to receive an E39/E40 light bulb 90 to screw therein. A shaped post 73 extends from the lamp down to the ground to complete the structure of the street lamp. However, the light bulb 90 of the conventional street lamp emits light in a radiating fashion so that the light rays L2 emitting from an upper portion of the light bulb 90 travels upward first to impinge the hood 70 and is then reflected down to the ground. This certainly deteriorates the brightness of such light rays. The light rays L1 emitting from a lower portion of the light bulb 90 are spread with the radiating angle so that the brightness for the area exactly below the street lamp may not be good. This is certainly not an idea arrangement of lighting. A practical test reveals that the conventional street lamp shows a light efficiency of only around 40-60%. In addition, although the outside shape of the conventional street lamp is often of such a design as to render low wind resistance and dust- and rain-proofness, yet internal heat dissipation is often very poor.

Recently, a variety of LED lighting devices have been developed and proposed. The LEDs is of such a characteristic as to emit light only frontward and rather than in a radiating form as that found in the light bulbs. Consequently, completely different accessories must be developed if the LEDs are to be used as street lamps and the equipment or facility of the conventional street lamp must thus be discarded. The whole system of the street lamp must be changed and this is extremely expensive and a waste also. Further, a known LED based street lamp is often constructed by arranging the LEDs in an array to serve a light source of the street lamp. This makes a limited area exactly below the street lamp sufficiently bright and a circumferential area is comparatively dim. The overall lighting is poor. This is a blind spot of the known LED lighting devices.

### SUMMARY OF THE INVENTION

The primary objective of the present invention is to provide a street lamp, which is constructed by combining heat pipes and lamp components in such a way that each heat pipe has a side surface to which LEDs are mounted so that the heat generated by the LEDs can e immediately dissipated away by the heat pipe to thereby overcome the issue of heat dissipation found in the conventional street lamp and also allows of the use of the existing street lamp to thereby reduce the cost.

Another objective of the present invention is to provide an arrangement in which a base and a lamp body are allowed to rotate relative to each other and are thus usable in the existing lighting devices and allow of adjustment of light projection direction of the street lamp. Such an arrangement allows the street lamp according to the present invention to be usable in an existing street lamp (such as E39/E40 or similar standards) to provide a street lamp of which the direction of projection of LED light is adjustable.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing the present invention.

FIG. 2 is an exploded view showing a base and a lamp body according to the present invention.

FIG. 3 is an exploded view showing spatial relationship of the lamp body according to the present invention.

FIG. 4 is an exploded view showing a base, a rotary seat, and an end cover according to the present invention.

FIG. 5 is an end view showing a lamp component according to the present invention.

FIG. 6 is a perspective view, partly sectioned, showing spatial relationship of the present invention.

FIG. 7 is a cross-sectional view showing the condition where the present invention is mounted to an existing street lamp with the lamp body being rotatably set at the optimum position.

FIG. 8 is a cross-sectional view illustrating light projection of the present invention mounted to an existing street lamp.

FIG. 9 illustrates a lamp component according to a second embodiment of the present invention.

FIG. 10 is an exploded view of the second embodiment of the present invention, illustrating equivalent replacement of the lamp component.

FIG. 11 is a perspective view, partly sectioned, of the second embodiment of the present invention.

FIG. 12 is an exploded view of a third embodiment of the present invention, illustrating modification of heat pipe.

FIG. 13 is a cross-sectional view of the third embodiment of the present invention, illustrating the combination of heat pipes and lamp components.

FIG. 14 is a perspective view showing the third embodiment of the present invention in an assembled form.

FIG. 15 is a schematic view illustrating a conventional street lamp.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

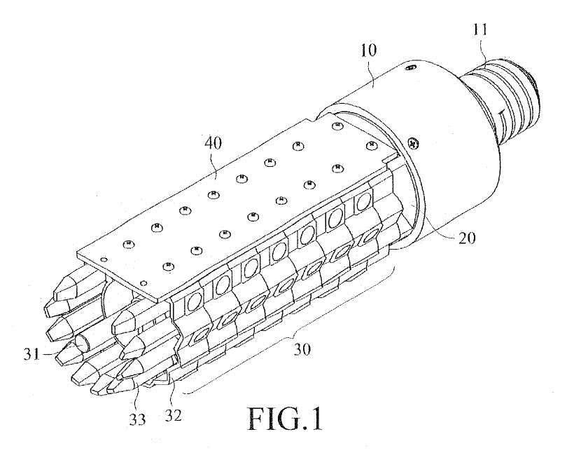

With reference to the drawings and in particular to FIGS. 1, 2, and 4, the present invention comprises the following components:

A base 10 receives and retains therein basic circuit components (not shown). The base has an end forming a connection head 11 and an opposite end forming a receiving chamber 12. The receiving chamber 12 has a circumferential wall forming at least one sideway hole 13. A fastener 14 (such as a screw) is received through the sideway hole 13 for fastening purposes.

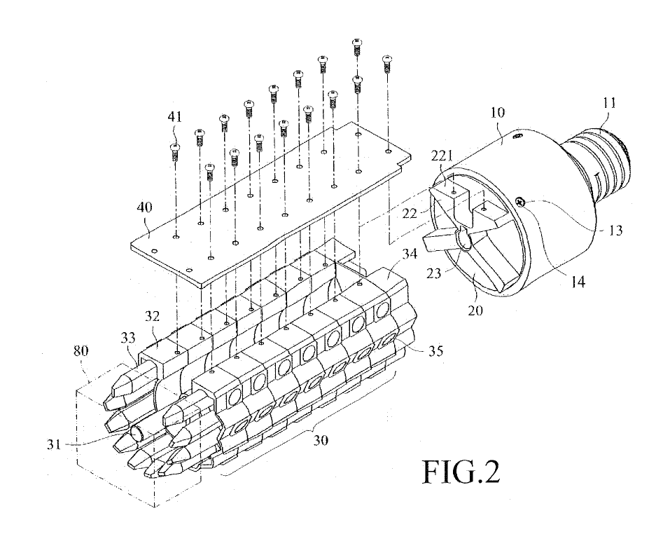

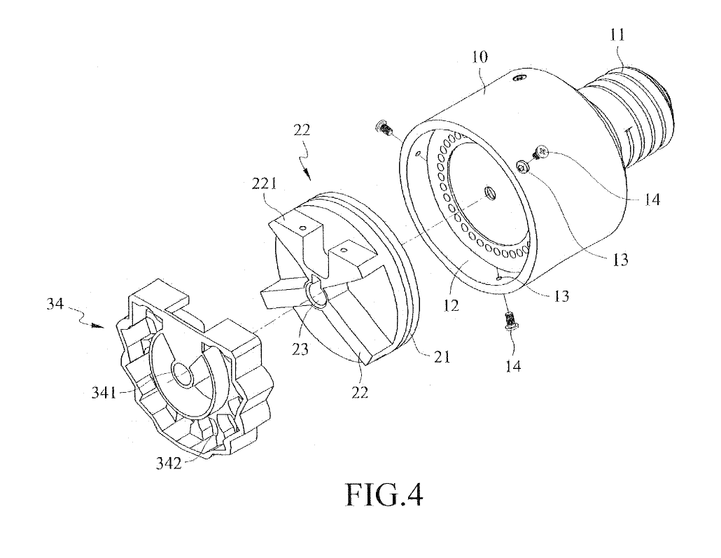

Referring to FIGS. 2 and 4, a rotary seat 20 is mounted inside the receiving chamber 12 of the base 10 and has a circumferential surface forming a circumferential groove 21. The circumferential groove 21 is set in registration with the sideway hole 13 of the receiving chamber 12. The rotary seat 20 has an outer end surface that is raised to form ribs 22. In the embodiment illustrated, the ribs 22 collectively define an X shape, but are not limited to such a shape. An end of the X-shape of the ribs 22 is flattened to form a planar positioning section 221. Further, the rotary seat 20 forms a central bore 23.

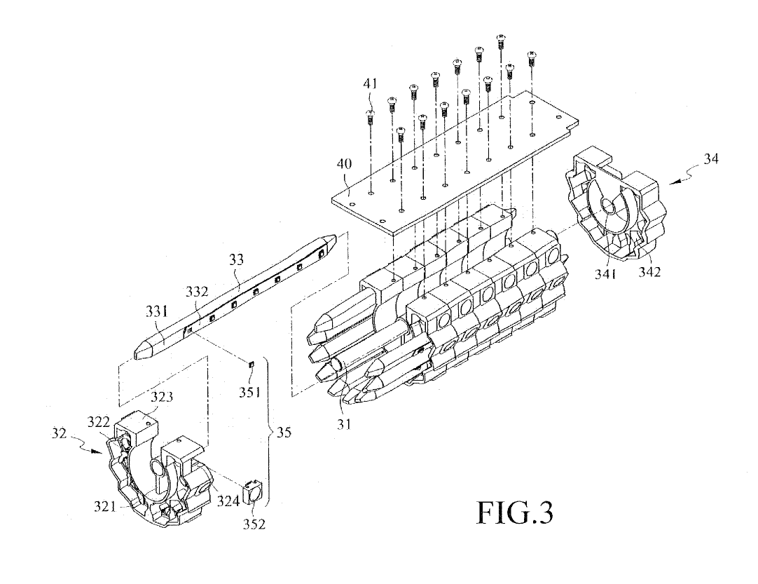

Referring to FIGS. 2 and 3, a lamp body 30 comprises a support post 31 and a plurality of heat pipes 33 that collectively constitute a main framework of the lamp body 30. The heat pipes 33 forms, on least at a side surface (namely the outside surface), a flat surface 331 and a flexible circuit board 332 (such as a flexible print circuit, FPC) is mounted to the flat surface 331. The flexible circuit board 332 comprises a plurality of spaced LED-based light emission bodies 351. Each of the light emission bodies 351 is used in combination with a lens assembly 352 to form a lighting module 35 (see FIG. 3).

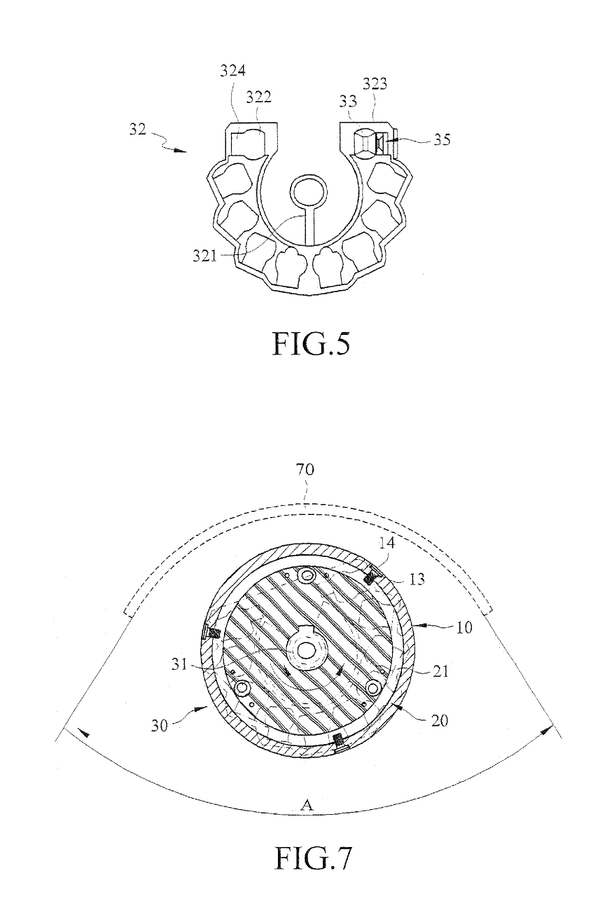

As shown in FIGS. 2, 5, and 6, a plurality of lamp components 32 is provided, each having a form of a circular or an annular structure having a circumferential surface forming a plurality of troughs 324, which provide spaces for respectively accommodating the lighting modules 35. To prevent any undesired waste of light emitting from the street lamp, the troughs 324 are generally arranged at two lateral side portions and a bottom portion of each of the lamp component, whereby the lamp component 32 has a portion (namely the top portion) where no trough 324 is formed in a top portion and instead a bearing surface 323 is formed for bearing a retention board 40 that is fixed in position by fasteners 41. Each of the lamp components 32 forms, centrally, a guide channel 321 through which the support post 31 extends or is inserted, and also forms a plurality of through holes 322 in a circumferential edge portion to receive the heat pipes 33 therethrough

As shown in FIGS. 2, 3, and 6, an end cover 34, which can be of a configuration similar to the lamp components 32 or can be simply replaced by one of the lamp component 32, forms a guide channel 341 through which the support post 31 extends or is inserted in a center thereof and a plurality of insertion cavities 342 to receive and retain the heat pipes 33.

The retention board 40 is positioned on the positioning section 221 of the rotary seat 20 and the bearing surface 323 of the lamp component 32 and is fixed by the fasteners 41 (such as screws), whereby the support post 31, the lamp components 32, the heat pipes 33, and the end cover 34 are all assembled or fixed together to constitute the lamp body 30, which is rotatable with the rotary seat 20.

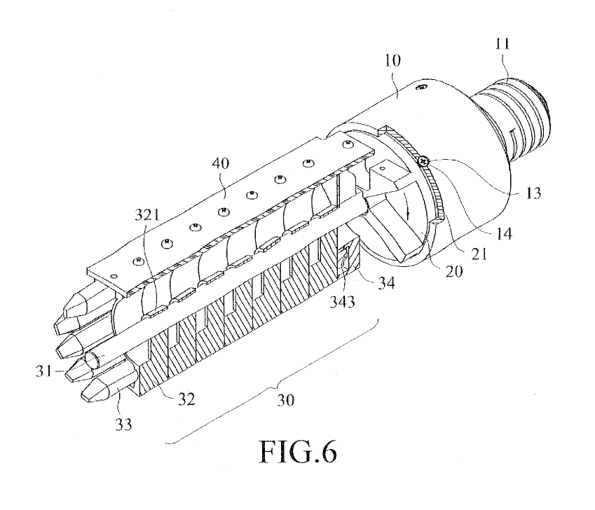

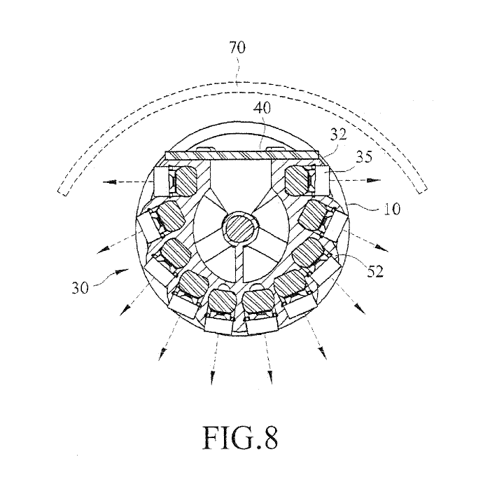

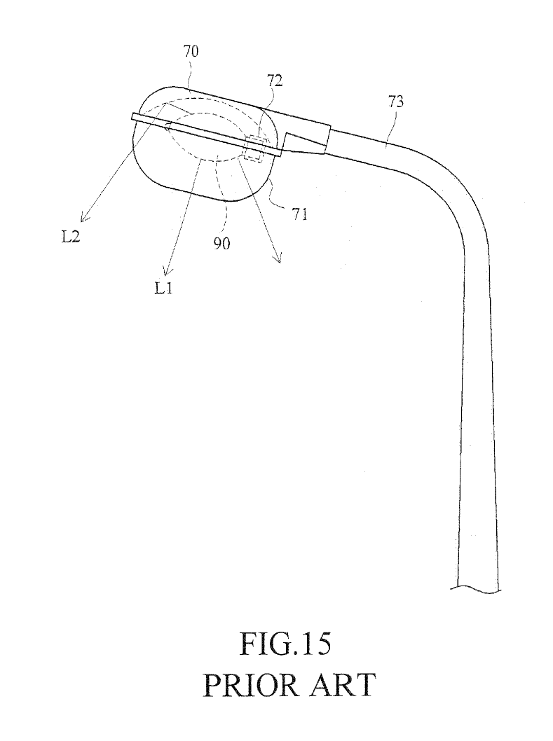

When the present invention is assembled to a socket 72 of a conventional street lamp shown in FIG. 15, as illustrated in FIG. 7 (also see FIG. 6), the rotary seat 20 that is mounted inside the base 10 has a circumferential surface forming a circumferential groove 21 and is supported in position by fasteners 14 extending through the base 10 so that the lamp body 30 can be rotated and angularly moved with the rotary seat 20 by any desired angle θ. As a result, as shown in FIG. 8, the light can be angularly set to irradiate a large area below the street lamp. Since no lighting module 35 is set in a direction toward the hood 70, no light is emitted in such a direction and thus no light is wasted.

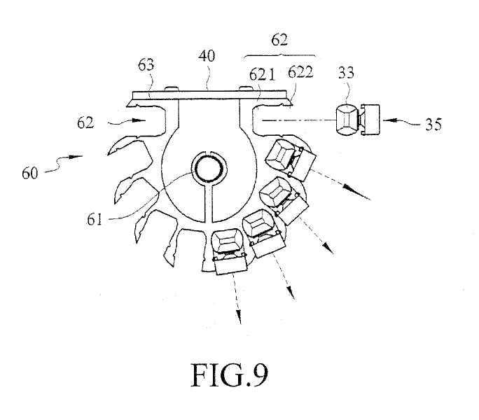

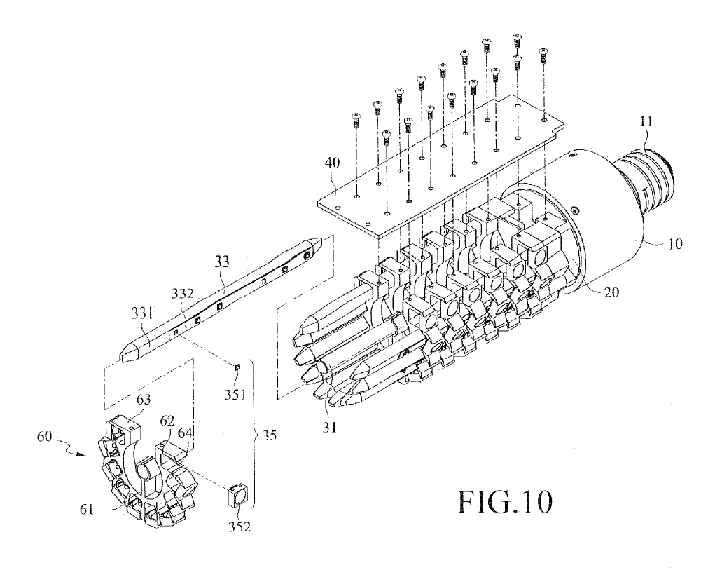

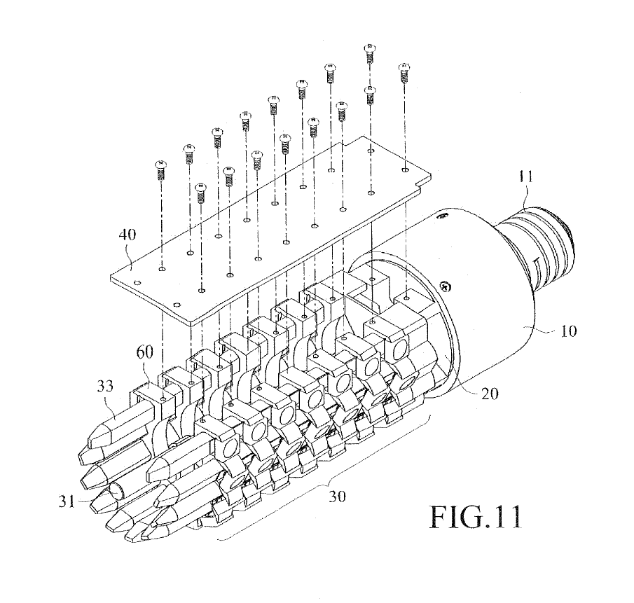

Referring to FIG. 9, a structure of a second embodiment according to the present invention is shown, in which the lamp component 60 comprises a centrally located guide channel 61 and a bearing surface 63 formed in a top portion thereof. However, each of the through holes 621 for the heat pipes and each of the troughs 622 for the lighting modules are combined to form a single inwardly recessed sideway slot 62 that is in communication with the outside, whereby the respective heat pipe 33 and the respective lighting module 35 can be directly inlaid in the sideway slot 62 of the lamp component 60. The overall structural arrangement is illustrated in FIGS. 10 and 11 and it preserves the convenience of use and maintains the feature of the present invention.

Referring to FIG. 2, a heat dissipation device 80, which can be of any of various means of heat dissipation, such as heat dissipation fins or a heat dissipation fan, can be arranged at an end of the lamp body 30 and coupled to the heat pipes 33 to provide improved heat dissipation.

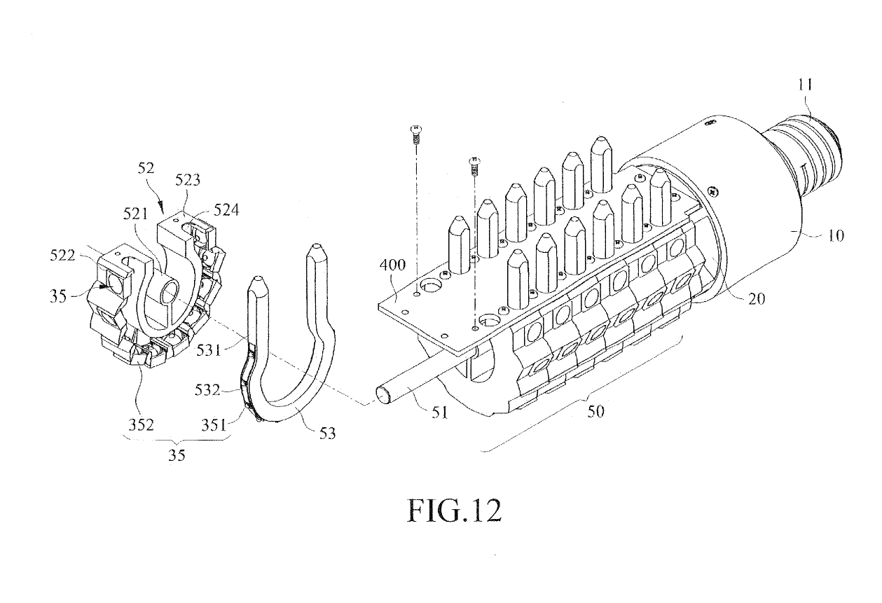

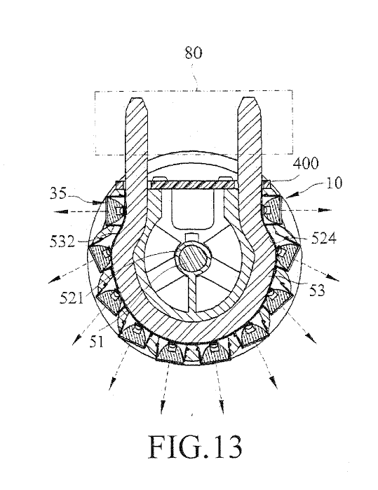

Referring to FIGS. 12 and 13, a structure of a third embodiment of the present invention is shown, in which the lamp body 50 comprises a support post 51 mounted at a center thereof and heat pipes 53 that are curved structures arranged at a circumferential portion thereof. In the embodiment illustrated, the heat pipes are of a U-shape having an outside surface forming a flattened surface 531 to which a flexible circuit board 532 is mounted. The flexible circuit board 532 comprises a plurality of spaced LED-based light emission bodies 351, each of which is in combination with a lens assembly 352 to form a lighting module 35.

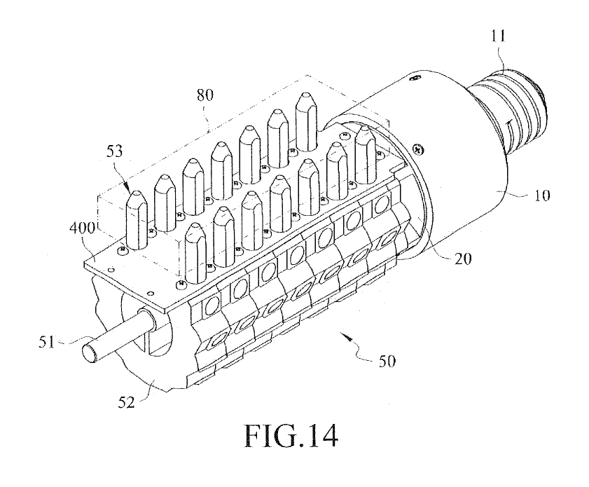

A plurality of lamp components 52 is attached, in a cascade form, to the support post 51 and is of the circular or annular structure described above, in which a guide channel 521 is formed in a center thereof and troughs 522 are formed in a side surface thereof. Also, a top portion of each lamp component forms a bearing surface 523. However, a receiving recess 524 is formed in an end surface of the lamp component to receive the heat pipe 53. Such a structure preserve the original design in such a way that heat generated by the lighting modules 35 are directly conducted off by the heat pipes 53 and transmitted to the ends of the heat pipes. With such an arrangement, the retention board 400 may be structured to receive ends of the heat pipes 35 to extend therethrough without affecting the original function thereof. Referring to FIG. 14, a heat dissipation device 80, which can be of any of various means of heat dissipation, such as heat dissipation fins or a heat dissipation fan, can be arranged at the portions of the heat pipes 53 extending outside the lamp components 52 to provide improved heat dissipation.

The retention board 40 that is shown for example in FIG. 1 is not subjected to any specific limitation in shape and can be of any desired shape, not limited to the rectangular shape illustrated in the drawings and, instead, a tubular or curved configuration may be adopted.

Referring to FIGS. 8, 9, and 13, the lamp component 23, 52, 60 illustrated comprises lighting modules 35 arranged at a circumferential surface thereof for projecting lights in various directions, whereby the light sources are arranged in a spaced manner by predetermined intervals. Such a distributed arrangement of multiple arrays projects light in a direction away from the hood and toward the site where uniform lighting is desired so that bright and uniform lighting may be obtained.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An LED street lamp, at least comprising:
a base that is adapted to receive therein basic circuit components and has an end forming a connection head and an opposite end forming a receiving chamber, the receiving chamber having a circumferential wall to which at least one fastener is attached;
a rotary seat, which is mounted inside the receiving chamber of the base, the rotary seat forming a central bore;
a lamp body, which comprises a support post and a plurality of heat pipes that collectively form a main framework of the lamp body, each of the heat pipes having a side surface forming a flat surface, a flexible circuit board being mounted to the flat surface, the flexible circuit board comprising a plurality of spaced LED-based light emission bodies, each of which is used in combination with a the lens assembly to form a lighting module; and
a plurality of lamp components, each of which is of a circular or annular structure having a circumferential surface forming a plurality of troughs, the lamp component forming in a center thereof a guide channel through which the support post extends and also forming, in a circumferential edge portion thereof, a plurality of through holes that receives the heat pipes to respectively extend therethrough, wherein the plurality of lamp components is arranged in a cascade and connected form to be rotatable with the rotary seat.

2. The LED street lamp according to claim 1, wherein the receiving chamber of the base comprises a fastener attached to the circumferential wall thereof and the rotary seat forms a circumferential groove in a circumferential surface thereof, the fastener having an end engaging in the circumferential groove.

3. The LED street lamp according to claim 1, wherein the rotary seat has an outer end surface that is raised to form ribs.

4. The LED street lamp according to claim 1, wherein each of the lamp components forms the troughs in opposite side portions and a bottom portion of the lamp component.

5. The LED street lamp according to claim 1, wherein the lamp components of the lamp body form in top portions thereof a bearing surface on which a retention board positioned and is fixed by fasteners.

6. The LED street lamp according to claim 1, wherein an end cover is arranged between the rotary seat and the lamp components of the lamp body and has a configuration similar to the lamp components, in which a guide channel is formed in a center thereof to receive the support post to extend therethrough and a plurality of insertion cavities is defined to receive and retain the heat pipes therein.

7. The LED street lamp according to claim 1, wherein each of the through holes of the lamp component is joined with the respective one of the troughs to form an inwardly recessed sideway slot that is in communication with the outside.

8. The LED street lamp according to claim 1, wherein the lamp body comprises a heat dissipation device arranged at an end thereof and coupled to the heat pipes.

9. An LED street lamp, at least comprising:
a base that is adapted to receive therein basic circuit components and has an end forming a connection head and an opposite end forming a receiving chamber, the receiving chamber having a circumferential wall to which at least one fastener is attached;
a rotary seat, which is mounted inside the receiving chamber of the base, the rotary seat forming a central bore;
a lamp body, which comprises a support post and a plurality of heat pipes that collectively form a main framework of the lamp body, each of the heat pipes forming a curved structure and having two ends extending outside the lamp body and forming a flattened surface on an outer side thereof to which a flexible circuit board is mounted, the flexible circuit board comprising a plurality of spaced LED-based light emission bodies, each of which is used in combination with a the lens assembly to form a lighting module; and
a plurality of lamp components, each of which is of a circular or annular structure having a circumferential surface forming a plurality of troughs, the lamp component forming in a center thereof a guide channel through which the support post extends and also forming a receiving recess in an end surface thereof to receive therein the heat pipe, wherein the plurality of lamp components is arranged in a cascade and connected form to be rotatable with the rotary seat.

10. The LED street lamp according to claim 9, wherein a heat dissipation device is coupled to portions of the heat pipes that extend outside the lamp body.
